(19) United States
(12) Patent Application Publication
(10) Pub. No.: US 2020/0266479 A1
(43) Pub. Date: Aug. 20, 2020

(54) LITHIUM SOLID-STATE BATTERY, AND METHOD FOR MANUFACTURING A LITHIUM SOLID-STATE BATTERY

(71) Applicant: Robert Bosch GmbH, Stuttgart (DE)

(72) Inventors: Thomas Hupfer, Weil Der Stadt (DE); Ingo Kerkamm, Stuttgart (DE); Lothar Kunz, Celle (DE)

(21) Appl. No.: 16/649,309

(22) PCT Filed: Oct. 10, 2018
(86) PCT No.: PCT/EP2018/077590

§ 371 Date: Mar. 20, 2020

(30) Foreign Application Priority Data
Oct. 25, 2017 (DE) 10 2017 219 170.8

(51) Int. Cl. H01M 10/0525; H01M 10/0585; H01M 4/1315

(52) U.S. Cl. CPC H01M 10/0525; H01M 4/1315; H01M 10/0585

(57) ABSTRACT

A lithium solid-state battery. The battery includes a lithium anode, a cathode, and a first separator layer electrically separating the lithium anode from the cathode. The first separator layer includes a sulfidic solid-state electrolyte. The battery also includes a second separator layer electrically separating the lithium anode from the cathode. The second separator layer is between the first separator layer and the lithium anode, and includes a sulfidic solid-state electrolyte. The first separator layer is between the cathode and the second separator layer and has a greater layer thickness than the second separator layer. The first separator layer has a layer thickness at least twice that of the second separator layer. The first separator layer preferably has a layer thickness at least ten times that of the second separator layer. The porosity of the second separator layer is in a range of approximately 0% to approximately 4%.

### FIELD

The present invention relates to a lithium solid-state battery and a method for manufacturing a lithium solid-state battery.

### BACKGROUND INFORMATION

Lithium solid-state batteries, which are secondary batteries, have high energy densities (>400 Wh/kg) when pure lithium metal, for example, is used as anode material. The class of sulfidic or sulfur-based solid-state electrolytes provides high ion conductivity, but dendrites may grow through the separator, in particular at high charge densities. Dendrites that grow through the separator may result in short circuits between the anodes and the cathode of the battery. The charge density of the lithium solid-state batteries is thus limited.

U.S. Patent App. Pub. Nos. US 2016/285064, US 2016/344035, and US 2013/017432 describe batteries according to the related art.

Conventional separators reduce or prevent dendrite growth through the separator; however, manufacturing the separators with a sufficient layer thickness is very complicated and costly, so that the solid-state lithium battery is very expensive.

### SUMMARY

Specific example embodiments of the present invention may advantageously allow a lithium solid-state battery, or manufacture of a lithium solid-state battery, that may be charged with particular high charge densities without dendrites growing through the separator.

According to a first aspect of the present invention, an example lithium solid-state battery is provided that includes a lithium anode, a cathode, and a first separator layer for electrically separating the lithium anode from the cathode, the first separator layer including a sulfidic solid-state electrolyte, and a second separator layer for electrically separating the lithium anode from the cathode, the second separator layer being situated between the first separator layer and the lithium anode, and the second separator layer including a sulfidic solid-state electrolyte, the first separator layer being situated between the cathode and the second separator layer and having a greater layer thickness than the second separator layer, the first separator layer in particular having a layer thickness at least twice that of the second separator layer, the first separator layer preferably having a layer thickness at least ten times that of the second separator layer, the porosity of the second separator layer being in a range of approximately 0% to approximately 4%, preferably in a range of approximately 0% to approximately 3%, particularly preferably in a range of approximately 0% to approximately 1%.

One advantage is that the lithium solid-state battery may generally be charged with particularly high charge densities (>3C=60/3; i.e., the lithium solid-state battery may be completely charged within 20 minutes) without dendrites growing through the separator layers. Dendrite growth is generally reliably prevented due to the low porosity of the second separator layer. In addition, the lithium solid-state battery is generally manufacturable in a particularly cost-effective and technically simple manner, since the overall thickness of the separator layer is made up of two layer thicknesses, namely, the first separator layer and the second separator layer. In particular, the lithium solid-state battery generally has a cost-effective and technically simple design, since the second separator layer has a thinner design than the first separator layer. Thus, the lithium solid-state battery is generally cost-effective even when the second separator layer is relatively expensive and technically complicated.

According to a second aspect of the present invention, an example method for manufacturing a lithium solid-state battery is provided, the method including the following steps: providing a lithium anode; providing a cathode; arranging a first separator layer for electrically separating the lithium anode from the cathode in such a way that in the completely manufactured lithium solid-state battery, the first separator layer is situated between the lithium anode and the cathode, the first separator layer including a sulfidic solid-state electrolyte; and arranging a second separator layer for electrically separating the lithium anode from the cathode in such a way that in the completely manufactured lithium solid-state battery, the second separator layer is situated between the first separator layer and the lithium anode, the second separator layer including a sulfidic solid-state electrolyte, the first separator layer having a greater layer thickness than the second separator layer, the first separator layer in particular having a layer thickness at least twice that of the second separator layer, the first separator layer preferably having a layer thickness at least ten times that of the second separator layer, the porosity of the second separator layer being in a range of approximately 0% to approximately 4%, preferably in a range of approximately 0% to approximately 3%, particularly preferably in a range of approximately 0% to approximately 1%.

It is advantageous that a lithium solid-state battery, which may generally be charged with particularly high charge densities (>3C=60/3; i.e., the lithium solid-state battery may be completely charged within 20 minutes), is or may be manufactured without dendrites growing through the separator layers. Dendrite growth in the manufactured lithium solid-state battery is generally reliably prevented due to the low porosity of the second separator layer. In addition, the lithium solid-state battery may generally be manufactured in a particularly cost-effective and technically simple manner, since the overall thickness of the separator layer is made up of two layer thicknesses, namely, the first separator layer and the second separator layer. In particular, the lithium solid-state battery is generally manufacturable in a cost-effective and technically simple manner, since the second separator layer has a thinner design than the first separator layer. Thus, the lithium solid-state battery may generally be manufactured cost-effectively, even when the second separator layer is relatively expensive or technically complicated.

Specific embodiments of the present invention may be regarded as based, among other things, on the aspects and findings described below.

According to one specific embodiment of the present invention, the first separator layer has a layer thickness in the range of approximately 1 μm to approximately 40 μm, in particular in the range of approximately 2 μm to approximately 30 μm, preferably in the range of approximately 5 μm to approximately 30 μm, and the second separator layer has a layer thickness in the range of approximately 0.2 μm to approximately 5 μm. It is advantageous that the first separator layer generally is or may be used as a mechanical substrate or backbone of the second separator layer.

The second separator layer may therefore generally have a particularly thin design. The first separator layer may generally have a flexible or bendable design.

According to one specific embodiment of the present invention, the first separator layer has a porosity in the range of approximately 5% to approximately 20%, in particular in the range of approximately 5% to approximately 10%. It is thus possible for the first separator layer to generally have a particularly simple technical design. This generally lowers the manufacturing costs of the lithium solid-state battery.

According to one specific embodiment of the present invention, the second separator layer is doped with halogen ions to improve the electrochemical stability with respect to the lithium anode. The durability of the lithium solid-state battery is thus generally improved, since an impairment of or chemical change in the second separator layer is prevented or at least reduced.

According to one specific embodiment of the present invention, the cathode includes a sulfidic solid-state electrolyte. One advantage is that the cathode may generally have a technically simple and cost-effective design. This lowers the manufacturing costs of the lithium solid-state battery. A sulfidic solid-state electrolyte may in particular include or be glass (Li₂S/P₂S₅ (70/30-80/20)), glass ceramic (Li₂S/P₂S₅ with crystalline precipitants such as Li₇P₃S₁₁), LGPS (Li₁₀GeP₂S₁₂, Li₁₀SnP₂S₁₂, Li_{9.54}Si_{1.74}P_{1.44}S_{11.7}Cl_{0.3}, Li_{9.6}P₃S₁₂, and/or Li₁₀XXP₂S₁₂ (with iodine)) and/or argyrodite (Li₇PS₆, Li₆PS₅Cl, Li₆PS₅I, and/or Li₆PS₅Br).

According to one specific embodiment of the example method according to the present invention, the first separator layer has a layer thickness in the range of approximately 1 μm to approximately 40 μm, in particular in the range of approximately 2 μm to approximately 30 μm, preferably in the range of approximately 5 μm to approximately 30 μm, and the second separator layer has a layer thickness in the range of approximately 0.2 μm to approximately 5 μm. In this method it is advantageous that the first separator layer generally is or may be used as a mechanical substrate or backbone of the second separator layer. It is thus possible for the second separator layer to generally have a particularly thin design. The first separator layer may generally have a flexible or bendable design.

According to one specific embodiment of the example method according to the present invention, the second separator layer is produced with the aid of solution deposition, an aerosol-based deposition method (“kinetic cold compaction”), or via a vacuum-based deposition process. In this way, the second separator layer may generally be formed in a technically simple manner.

According to one specific embodiment of the example method according to the present invention, the first separator layer is produced with the aid of tape casting. One advantage is that the first separator layer may generally be manufactured in a technically simple and cost-effective manner. This generally lowers the manufacturing costs of the lithium solid-state battery.

According to one specific embodiment of the example method according to the present invention, the second separator layer is doped with halogen ions to improve the electrochemical stability with respect to the lithium anode. The durability of the lithium solid-state battery is thus generally improved, since an impairment of or chemical change in the second separator layer is prevented or at least reduced.

It is pointed out that some of the possible features and advantages of the present invention are described herein with reference to different specific embodiments of the lithium solid-state battery or of the method for manufacturing a lithium solid-state battery. One skilled in the art recognizes that the features may be suitably combined, modified, or exchanged to arrive at further specific embodiments of the present invention.

### BRIEF DESCRIPTION OF THE DRAWING

Specific embodiments of the present invention are described below with reference to the appended drawing; neither the drawing nor the description are/is to be construed as limiting to the present invention.

FIG. 1 shows a cross-sectional view of a lithium solid-state battery according to one specific example embodiment of the present invention.

The FIGURE is strictly schematic and not true to scale. Identical or functionally equivalent features are denoted by the same reference numerals in the FIGURE.

### DETAILED DESCRIPTION OF EXAMPLE EMBODIMENTS

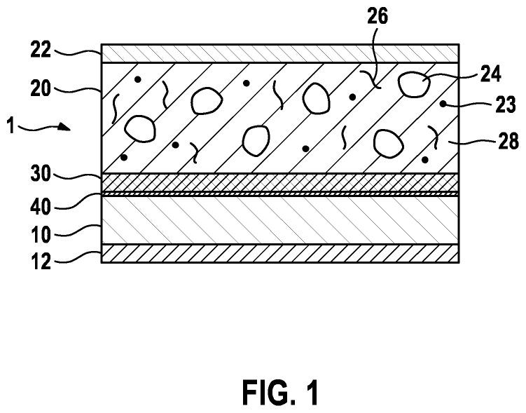

FIG. 1 shows a cross-sectional view of a lithium solid-state battery according to one specific embodiment of the present invention.

Rechargeable lithium solid-state battery 1 (secondary battery) includes a lithium anode 10 and a cathode 20.

Lithium anode 10 may include a tape made of pure lithium, lithium on a metal substrate (such as copper, nickel, or a combination thereof), or a lithium alloy (LiMg, for example).

Cathode 20 may include a sulfidic or sulfur-based solid-state electrolyte 28 and an active cathode material 24 that is situated in solid-state electrolyte 28. Active cathode material 24 may be embedded in the form of grains (polycrystalline or monocrystalline) in a binder 23 of cathode 20. Active cathode material 24 may include an (outer) coating for reducing the resistance at the transition from active cathode material 24 to binder 23. The coating may include or be LiNbO₃, for example. However, it is also possible for active cathode material 24 to include no (outer) coating. Cathode 20 may include a conductive additive 26 such as a carbon compound (C compound).

A cathode current collector 22, in the form of a layer, which is electrically connected to a positive pole of lithium solid-state battery 1 is situated on a first side of cathode 20 (above cathode 20 in FIG. 1). A first separator layer 30 is situated on second side of cathode 20 facing away from the first side (below cathode 20 in FIG. 1). First separator layer 30 is situated in direct contact with cathode 20. First separator layer 30 may have a porous design. In particular, the porosity of first separator layer 30 may be in the range of approximately 5% to approximately 20%, in particular in the range of approximately 5% to approximately 10%.

First separator layer 30 may include binder 23 or binder material in a volume percentage of approximately 0.5% to approximately 10%, in particular approximately 3%. First separator layer 30 may include a sulfidic solid-state electrolyte.

First separator layer 30 has a layer thickness of approximately 2 μm to approximately 30 μm, in particular approximately 5 μm to approximately 20 μm, preferably approximately 10 μm to approximately 15 μm. First separator layer 30 has a greater layer thickness than second separator layer 40.

First separator layer 30 may be used as a mechanical backbone for second separator layer 40. First separator layer 30 may have a partially flexible or bendable design due to the binder or binder material.

First separator layer 30 may have a crystalline or amorphous design. It is also possible for first separator layer 30 to be a mixture of crystalline and amorphous designs, or to have a crystalline design in some areas and an amorphous design in some areas.

First separator layer 30 may include grain boundaries. First separator layer 30 may be produced by tape casting (conventional tape casting method).

Second separator layer 40 may include a sulfidic solid-state electrolyte. Second separator layer 40 is in direct contact with lithium anode 10. Second separator layer 40 is in direct contact with first separator layer 30 on the side of second separator layer 40 opposite from lithium anode 10.

Second separator layer 40 may include essentially no pores or cavities. The porosity of second separator layer 40 may be in the range of approximately 0% to approximately 3%, in particular in a range of approximately 0% to approximately 1%. A porosity in the range of approximately 0% to approximately 2% is also possible. The range of approximately 0.1% to approximately 1.5% is likewise possible.

The porosity of second separator layer 40 (also referred to as the second separating layer) is (much) less than the porosity of first separator layer 30 (also referred to as the first separating layer). In particular, the porosity of first separator layer 30 may be in the range of approximately 10% or approximately 5%. For example, the porosity of first separator layer 30 is in a range of approximately 5% to approximately 7%. A porosity of first separator layer 30 in a range of approximately 7% to approximately 10% is also possible.

The ratio of the porosity of second separator layer 40 to the porosity of first separator layer 30 may, for example, be in a range of approximately 0.01 to approximately 0.5, in particular in a range of approximately 0.1 to approximately 0.3, preferably in a range of approximately 0.1 to approximately 0.2 for example approximately 0.15. It is also possible for the ratio (independently of the porosity of first separator layer 30) to be essentially zero, since the porosity of second separator layer 40 is essentially zero.

The porosity may in particular be a ratio of the cavity volume to the overall volume: cavity volume/overall volume.

Second separator layer 40 or the sulfidic solid-state electrolyte of the second separator layer may be doped with halogen ions. The electrochemical stability and the boundary surface resistance with respect to lithium anode 10 may thus be improved. The doping may in particular be situated in an area in which an argyrodite is present or forms. In particular, the second separator layer may include or be Li₇PS₆, Li₆PS₅Cl, Li₆PS₅I, and/or Li₆PS₅Br. The argyrodite, the LGPS, or the glass ceramic may have a conductivity in the range of approximately 10⁻³ S/cm to approximately 10⁻² S/cm at room temperature. The glass may have a conductivity in the range of approximately 10⁻⁴ S/cm to approximately 10⁻³ S/cm at room temperature.

The layer thickness, i.e., the thickness in the direction from top to bottom in FIG. 1, of second separator layer 40 may be in a range of approximately 0.2 μm to approximately 5 μm. Second separator layer 40 is (much) thinner than first separator layer 30.

The ratio of the layer thicknesses between second separator layer 40 and first separator layer 30, i.e., the layer thickness of second separator layer 40/layer thickness of first separator layer 30, may be in a range of approximately 0.01 to approximately 0.3, in particular in a range of approximately 0.01 to approximately 0.2, preferably in a range of approximately 0.02 to approximately 0.4. For example, the ratio of the layer thicknesses may be approximately 0.09 to approximately 0.15.

The term “approximately” may in particular mean a deviation of ±5%, preferably ±2%, of the particular stated value.

Second separator layer 40 may be crystalline. Alternatively, it is also possible for second separator layer 40 to have an amorphous design. A mixture of these two forms, in particular partial areas of second separator layer 40 being crystalline and partial areas of second separator layer 40 being amorphous, is also possible.

Second separator layer 40 may be formed by solution deposition or by a vacuum-based deposition process (chemical vapor deposition, for example) or an aerosol-based cold deposition method (ADM). In aerosol-based cold deposition, particles in a suspension are accelerated and sprayed under high pressure onto a substrate, resulting in a dense layer.

Due to the low porosity of second separator layer 40, second separator layer 40 prevents the formation or penetration of lithium dendrites into second separator layer 40, and thus also prevents the penetration of dendrites into first separator layer 30, even at high charge densities. In this way, a short circuit of lithium solid-state battery 1 is prevented, and the service life of lithium solid-state battery 1 is increased.

Forming second separator layer 40 is generally more complicated than forming first separator layer 30. In order for second separator layer 40, which prevents the penetration or formation of dendrites, to have a (much) thinner design than first separator layer 30, the summed layer thickness of first separator layer 30 and of second separator layer 40 may be very large, and separator layers 30, 40 and therefore lithium solid-state battery 1 may still be quickly and cost-effectively manufactured. As a result, a lithium solid-state battery 1 in which dendrite growth is reliably prevented or greatly reduced may be manufactured quickly and cost-effectively in a technically simple manner.

A lithium anode current collector 12 in the form of a layer may be situated on the side of lithium anode 10 facing away from second separator layer 40. Lithium anode current collector 12 is connected to the negative pole of lithium solid-state battery 1.

Lastly, it is pointed out that terms such as “having,” “including,” etc., do not exclude other elements or steps, and terms such as “a” or “an” do not exclude a plurality.

1-10. (canceled)

11. A lithium solid-state battery, comprising:
a lithium anode;
a cathode;
a first separator layer electrically separating the lithium anode from the cathode, the first separator layer including a sulfidic solid-state electrolyte; and
a second separator layer electrically separating the lithium anode from the cathode, the second separator layer being situated between the first separator layer and the lithium anode, and the second separator layer including a sulfidic solid-state electrolyte;
wherein the first separator layer is situated between the cathode and the second separator layer and has a greater layer thickness than the second separator layer, the first separator layer having a layer thickness at least twice that of the second separator layer, a porosity of the second separator layer being in a range of approximately 0% to approximately 4%.

12. The lithium solid-state battery as recited in claim 11, wherein the layer thickness of the first separator layer is at least ten times that of the second separator layer.

13. The lithium solid-state battery as recited in claim 11, wherein the porosity of the second separator layer is in a range of approximately 0% to approximately 3%.

14. The lithium solid-state battery as recited in claim 11, wherein the porosity of the second separator layer is in a range of approximately 0% to approximately 1%.

15. The lithium solid-state battery as recited in claim 11, wherein the layer thickness of the first separator layer is in a range of approximately 1 μm to approximately 40 μm, and the second separator layer has a layer thickness in a range of approximately 0.2 μm to approximately 5 μm.

16. The lithium solid-state battery as recited in claim 11, wherein the layer thickness of the first separator layer is in a range of approximately 2 μm to approximately 30 μm, and the second separator layer has a layer thickness in a range of approximately 0.2 μm to approximately 5 μm.

17. The lithium solid-state battery as recited in claim 11, wherein the layer thickness of the first separator layer is in a range of approximately 5 μm to approximately 30 μm, and the second separator layer has a layer thickness in a range of approximately 0.2 μm to approximately 5 μm.

18. The lithium solid-state battery as recited in claim 11, wherein the first separator layer has a porosity in a range of approximately 5% to approximately 20%.

19. The lithium solid-state battery as recited in claim 11, wherein the first separator layer has a porosity in a range of approximately 5% to approximately 10%.

20. The lithium solid-state battery as recited in claim 11, wherein the second separator layer is doped with halogen ions to improve electrochemical stability with respect to the lithium anode.

21. The lithium solid-state battery as recited in claim 11, wherein the cathode includes a sulfidic solid-state electrolyte.

22. A method for manufacturing a lithium solid-state battery, the method comprising the following steps:
providing a lithium anode;
providing a cathode;
arranging a first separator layer, which electrically separates the lithium anode from the cathode, in such a way that in a completely manufactured lithium solid-state battery, the first separator layer is situated between the lithium anode and the cathode, the first separator layer including a sulfidic solid-state electrolyte; and
arranging a second separator layer, which electrically separates the lithium anode from the cathode, in such a way that in the completely manufactured lithium solid-state battery, the second separator layer is situated between the first separator layer and the lithium anode, the second separator layer including a sulfidic solid-state electrolyte;
wherein the first separator layer has a greater layer thickness than the second separator layer, the first separator layer having a layer thickness at least twice that of the second separator layer, and a porosity of the second separator layer is in a range of approximately 0% to approximately 4%.

23. The method as recited in claim 22, wherein the layer thickness of the first separator layer is at least ten times that of the second separator layer.

24. The method as recited in claim 22, wherein the porosity of the second separator layer is in a range of approximately 0% to approximately 3%.

25. The method as recited in claim 22, wherein the porosity of the second separator layer is in a range of approximately 0% to approximately 1%.

26. The method as recited in claim 22, wherein the layer thickness of the first separator layer is in a range of approximately 1 μm to approximately 40 μm, and the second separator layer has a layer thickness in a range of approximately 0.2 μm to approximately 5 μm.

27. The method as recited in claim 22, wherein the layer thickness of the first separator layer is in a range of approximately 2 μm to approximately 30 μm, and the second separator layer has a layer thickness in a range of approximately 0.2 μm to approximately 5 μm.

28. The method as recited in claim 22, wherein the layer thickness of the first separator layer is in a range of approximately 5 μm to approximately 30 μm, and the second separator layer has a layer thickness in a range of approximately 0.2 μm to approximately 5 μm.

29. The method as recited in claim 22, wherein the second separator layer is produced using solution deposition, or an aerosol-based deposition method, or via a vacuum-based deposition process.

30. The method as recited in claim 22, wherein the first separator layer is produced using tape casting.

31. The method as recited in claim 22, wherein the second separator layer is doped with halogen ions to improve electrochemical stability with respect to the lithium anode.
